(19) United States
(12) Patent Application Publication
(10) Pub. No.: US 2024/0355204 A1
(43) Pub. Date: Oct. 24, 2024

(54) SYSTEM AND METHOD FOR PREVENTING INTER-VEHICLE COLLISIONS AT INTERSECTIONS

(71) Applicant: Aleksei KUKISHEV, Palo Alto, CA (US)

(72) Inventor: Aleksei KUKISHEV, Palo Alto, CA (US)

(21) Appl. No.: 18/623,183

(22) Filed: Apr. 1, 2024

Related U.S. Application Data
(60) Provisional application No. 63/460,338, filed on Apr. 19, 2023.

(51) Int. Cl. G08G 1/16; G06V 20/58; G08G 1/01; G08G 1/0967

(52) U.S. Cl. CPC G08G 1/163; G06V 20/58; G08G 1/0141; G08G 1/096725; G08G 1/096791; G08G 1/166

(57) ABSTRACT

A system and method are provided, which allow avoiding inter-vehicle collisions at intersections. The system comprises a first sub-system mounted in a first vehicle and a second sub-system mounted in a second vehicle. Each of the sub-systems continuously receives navigation data with geographical coordinates of the corresponding vehicle after a threshold time period to determine that there is an intersection ahead. The first sub-system continuously broadcasts the navigation data of the first vehicle. The second sub-system continuously receives the broadcast navigation data and continuously compares the navigation data of the vehicles. If they are coincident, the second sub-system determines which of the vehicles must give way at the intersection based on traffic rules. If it is the second vehicle, the second sub-system notifies the first sub-system that it will take a collision avoidance action.

### TECHNICAL FIELD

The present disclosure relates to the field of road safety. In particular, the present disclosure relates to a system and method for preventing inter-vehicle collisions at intersections.

### BACKGROUND OF THE INVENTION

Most road accidents with severe consequences occur when motorized vehicles (e.g., cars, trucks, vans, busses, etc.) collide at intersections due to drivers' violation of the order in which they must pass the intersections. Collision avoidance systems installed on autopilot-equipped vehicles may prevent inter-vehicle collisions at intersections, but are not mass-produced because they are installed on models of certain manufacturers.

### SUMMARY OF THE INVENTION

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a technical solution that allows avoiding inter-vehicle collisions at intersections.

The objective above is achieved by the features of the independent claims in the appended claims. Further embodiments and examples are apparent from the dependent claims, the detailed description, and the accompanying drawings.

According to a first aspect, a system for preventing inter-vehicle collisions at an intersection is provided. The system comprises a first sub-system mounted in a first vehicle and a second sub-system mounted in a second vehicle. Each of the first and second vehicles is assumed to comprise brakes.

The first sub-system is configured to continuously receive first navigation data comprising geographical coordinates at which the first vehicle will be located upon expiry of a threshold time period. By using the first navigation data, the first sub-system is further configured to determine that the first vehicle is approaching the intersection along a first road. After said determination, the first sub-system is further configured to continuously broadcast the first navigation data.

The second sub-system is configured to continuously receive second navigation data comprising geographical coordinates at which the second vehicle will be located upon expiry of the threshold time period. By using the second navigation data, the second sub-system is further configured to determine that the second vehicle is approaching the intersection along a second road different from the first road. The second sub-system is further configured to continuously receive the first navigation data broadcast by the first sub-system and continuously compare the geographical coordinates comprised in the first navigation data with the geographical coordinates comprised in the second navigation data. If the geographical coordinates comprised in the first navigation data coincide with the geographical coordinates comprised in the second navigation data, the second sub-system is further configured to determine whether the second vehicle must give way to the first vehicle at the intersection based on traffic rules. If it is determined that the second vehicle must give way to the first vehicle at the intersection, the second sub-system is further configured to transmit a notification to the first sub-system. The notification indicates that the second sub-system will perform a collision avoidance action. After that, if a time until the geographical coordinates comprised in the first navigation data coincide with the geographical coordinates comprised in the second navigation data is less than a first threshold value, the second sub-system is further configured to perform the collision avoidance action by forcibly activating the brakes of the second vehicle.

The system thus configured may prevent inter-vehicle collisions at intersections. This is because, by comparing the navigation data of two (or more) vehicles (i.e. the geographical coordinates of each of them at certain time periods or intervals, e.g. 1, 2, 3 or more seconds or any other time units), it is possible to determine the moment and/or point at which their routes intersect at a particular intersection and to take measures in advance to prevent their collision. Furthermore, due to the above-mentioned notification transmitted from the second sub-system to the first sub-system, the first sub-system of the first vehicle may not take any measures to change the speed of the first vehicle, i.e., the first vehicle may continue to pass the intersection without the intervention of the first sub-system.

In one exemplary embodiment of the first aspect, the second sub-system is further configured to determine that the time until the geographical coordinates (of the first vehicle) comprised in the first navigation data coincide with the geographical coordinates (of the second vehicle) comprised in the second navigation data exceeds the first threshold value by a second threshold value. In this embodiment, the second sub-system is further configured to output a warning signal to a driver of the second vehicle. The warning signal indicates that the driver needs either to slow down the second vehicle or to fully stop the second vehicle. Thus, if there is sufficient time before the geographical coordinates of the first and second vehicles coincide (i.e., their potential collision at the intersection), their collision may be prevented by the driver taking measures in the form of smooth braking of the second vehicle.

In one exemplary embodiment of the first aspect, the warning signal is at least one of a visual signal and an audible signal. The use of one or both of these signals may more effectively encourage the driver to take independent action to brake/avoid a potential inter-vehicle collision.

In one exemplary embodiment of the first aspect, the second sub-system is further configured, if it is determined that the first vehicle must give way to the second vehicle at the intersection, to transmit another notification to the first sub-system. Said another notification indicates that: (i) a collision between the first vehicle and the second vehicle is possible, and (ii) the second sub-system will not perform the collision avoidance action. By using this notification, the first sub-system may be informed about the potential inter-vehicle collision and take measures to prevent it (e.g., forcibly activate the brakes of the first vehicle if there is insufficient time before the inter-vehicle collision)

In one exemplary embodiment of the first aspect, the second sub-system is further configured to receive information about time periods of green and red signals of a traffic light installed at the intersection. In this embodiment, the second sub-system is configured to determine whether the second vehicle must give way to the first vehicle at the intersection based on the received information. By doing so, the second sub-system may efficiently determine whether the first or second vehicle has the right of way at the intersection.

In one exemplary embodiment of the first aspect, the second sub-system is further configured to store a database of roadway signs within a geographical area covering the first road and the second road. The roadway signs are part of the traffic rules. In this embodiment, the second sub-system is configured to determine whether the second vehicle must give way to the first vehicle at the intersection based on the roadway signs. By doing so, the second sub-system may efficiently determine whether the first or second vehicle has the right of way at the intersection.

In one exemplary embodiment of the first aspect, if the second vehicle comprises a forward-facing camera or a drive recorder, the second sub-system is further configured to continuously receive a video image from the forward-facing camera or the drive recorder and determine whether a traffic light and/or roadway signs are present in the video image. If the traffic light and/or the roadway signs are present in the video image, the second sub-system is configured to determine whether the second vehicle must give way to the first vehicle at the intersection based on a current signal of the traffic light and/or the roadway signs. By doing so, the second sub-system may efficiently determine whether the first or second vehicle has the right of way at the intersection.

According to a second aspect, a method for preventing inter-vehicle collisions at an intersection is provided.

The method starts with the following steps performed by using a first sub-system mounted in a first vehicle. At first, first navigation data is continuously received, which comprises geographical coordinates where the first vehicle will be located upon expiry of a threshold time period. Then, the first navigation data is used to determine that the first vehicle is approaching the intersection along a first road. After that, the first navigation data begins to be broadcast continuously.

Further, the method proceeds to the following steps performed by using a second sub-system mounted in a second vehicle. At first, second navigation data is continuously received, which comprises geographical coordinates where the second vehicle will be located upon expiry of the threshold time period. Then, the second navigation data is used to determine that the second vehicle is approaching the intersection along a second road different from the first road. Next, the first navigation data broadcast by the first sub-system is received, whereupon the geographical coordinates comprised in the first and second navigation data are continuously compared to each other. If the geographical coordinates comprised in the first navigation data coincide with the geographical coordinates comprised in the second navigation data, it is determined whether the second vehicle must give way to the first vehicle at the intersection based on traffic rules. If the second vehicle must give way to the first vehicle at the intersection, a notification is transmitted to the first sub-system, which indicates that the second sub-system will perform a collision avoidance action. After that, if a time until the geographical coordinates comprised in the first navigation data coincide with the geographical coordinates comprised in the second navigation data is less than a first threshold value, the collision avoidance action is performed by forcibly activating the brakes of the second vehicle.

By comparing the navigation data of two (or more) vehicles (i.e. the geographical coordinates of each of them at certain time periods or intervals, e.g. 1, 2, 3 or more seconds or any other time units), it is possible to determine the moment and/or point at which their routes intersect at a particular intersection and to take measures in advance to prevent their collision. Furthermore, due to the above-mentioned notification transmitted from the second sub-system to the first sub-system, the first sub-system of the first vehicle may not take any measures to change the speed of the first vehicle, i.e., the first vehicle may continue to pass the intersection without the intervention of the first sub-system.

In one exemplary embodiment of the second aspect, the method comprises an additional step in which, if the time until the geographical coordinates comprised in the first navigation data coincide with the geographical coordinates comprised in the second navigation data exceeds the first threshold value by a second threshold value, the second sub-system outputs a warning signal to a driver of the second vehicle. The warning signal indicates that the driver needs either to slow down the second vehicle or to fully stop the second vehicle. Thus, if there is sufficient time before the geographical coordinates of the first and second vehicles coincide (i.e., their potential collision at the intersection), their collision may be prevented by the driver taking measures in the form of smooth braking of the second vehicle.

In one exemplary embodiment of the second aspect, the warning signal is at least one of a visual signal and an audible signal. The use of one or both of these signals may more effectively encourage the driver to take independent action to brake/avoid the potential inter-vehicle collision.

In one exemplary embodiment of the second aspect, the method comprises an additional step in which, if it is determined that the first vehicle must give way to the second vehicle at the intersection, the second sub-system transmits another notification to the first sub-system, which indicates that: (i) a collision between the first vehicle and the second vehicle is possible, and (ii) the second sub-system will not perform the collision avoidance action. By using this notification, the first sub-system may be informed about the potential inter-vehicle collision and take measures to prevent it (e.g., forcibly activate the brakes of the first vehicle if there is insufficient time before the inter-vehicle collision).

In one exemplary embodiment of the second aspect, the method comprises additional steps in which the second sub-system receives information about time periods of green and red signals of a traffic light installed at the intersection and uses the received information to determine whether the second vehicle must give way to the first vehicle at the intersection based on the received information. By doing so, the second sub-system may efficiently determine whether the first or second vehicle has the right of way at the intersection.

In one exemplary embodiment of the second aspect, the method comprises additional steps in which a database of roadway signs within a geographical area covering the first road and the second road is pre-stored in the second sub-system, whereupon the second sub-system determines whether the second vehicle must give way to the first vehicle at the intersection based on the roadway signs. By doing so, the second sub-system may efficiently determine whether the first or second vehicle has the right of way at the intersection.

In one exemplary embodiment of the second aspect, the method comprises additional steps in which, if the second vehicle comprises a forward-facing camera or a drive recorder, the second sub-system continuously receives a video image from the forward-facing camera or the drive recorder, determines whether a traffic light and/or roadway signs are present in the video image, and, if the traffic light and/or the roadway signs are present in the video image, determines whether the second vehicle must give way to the first vehicle at the intersection based on a current signal of the traffic light and/or the roadway signs. By doing so, the second sub-system may efficiently determine whether the first or second vehicle has the right of way at the intersection.

Other features and advantages of the present disclosure will be apparent upon reading the following detailed description and reviewing the accompanying drawings.

### BRIEF DESCRIPTION OF DRAWINGS

The present disclosure is explained below with reference to the accompanying drawings in which:

FIG. 1 shows a typical traffic situation that can end in an inter-vehicle collision at an intersection;

FIG. 2 schematically explains how the inter-vehicle collision can be prevented by using a system according to one exemplary embodiment; and

FIG. 3 shows a schematic block diagram of a sub-system of the system that is mounted in each vehicle according to one exemplary embodiment.

### DETAILED DESCRIPTION OF THE INVENTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus and method disclosed herein can be implemented in practice by using any numbers of the embodiments provided herein. Furthermore, any embodiment of the present disclosure can be implemented using one or more of the elements presented in the appended claims.

As used in the exemplary embodiments disclosed herein, a vehicle may refer to a means designed for the overland transport of persons, cargo or equipment installed thereon. Some examples of the vehicle may include, but not limited to, cars, passenger cars, trucks, light trucks, pickup trucks, buses, and motorbikes.

The exemplary embodiments disclosed herein relate to a technical solution that allows avoiding inter-vehicle collisions at intersections. For this purpose, each vehicle is equipped with a properly (and equally) configured sub-system. More specifically, the sub-system in each vehicle continuously receives navigation data comprising geographical coordinates at which the vehicle will be located upon expiry of a threshold time period (e.g., in 1, 2, 3 or more seconds), and uses the navigation data to determine the proximity of the vehicle to an upcoming intersection or road junction. For example, when a first sub-system mounted in a first vehicle determines that there is an intersection ahead, it may begin to continuously broadcast the navigation data of the first vehicle. If a sub-system mounted in a second vehicle also determines that the second vehicle is approaching the intersection but only along a different road, it may continuously receive the navigation data of the first vehicle and continuously compare the navigation data of the first and second vehicles. If the navigation data of the first and second vehicles are coincident, the second sub-system may determine which of the first and second vehicles has the right of way (or advantage) at the intersection based on traffic rules. If the second vehicle must give way to the first vehicle at the intersection, the second sub-system notifies the first sub-system that it will take a collision avoidance action. After that, when a time until the coincidence of the navigation data of the first and second vehicles is less than a threshold value, the second sub-system is configured to forcibly activate the brakes of the second vehicle.

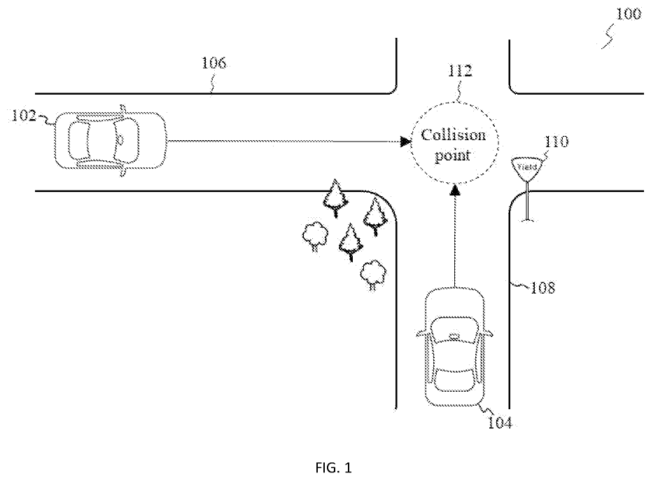

FIG. 1 shows a typical traffic situation 100 that can end in an inter-vehicle collision at an intersection. As can be seen from the traffic situation 100, two vehicles 102 and 104 are assumed to approach the intersection but on different roads, namely, the vehicle 102 is travelling on a road 106 and a vehicle 104 is travelling on a road 108. Due to different speeds of the vehicles 102 and 104 and their different distances from the intersection, they are expected to be at the intersection at the same time. If the driver of the vehicle 104 fails to notice a “Yield” sign 110 before the intersection, it could result in the inter-vehicle collision at a collision point or zone 112.

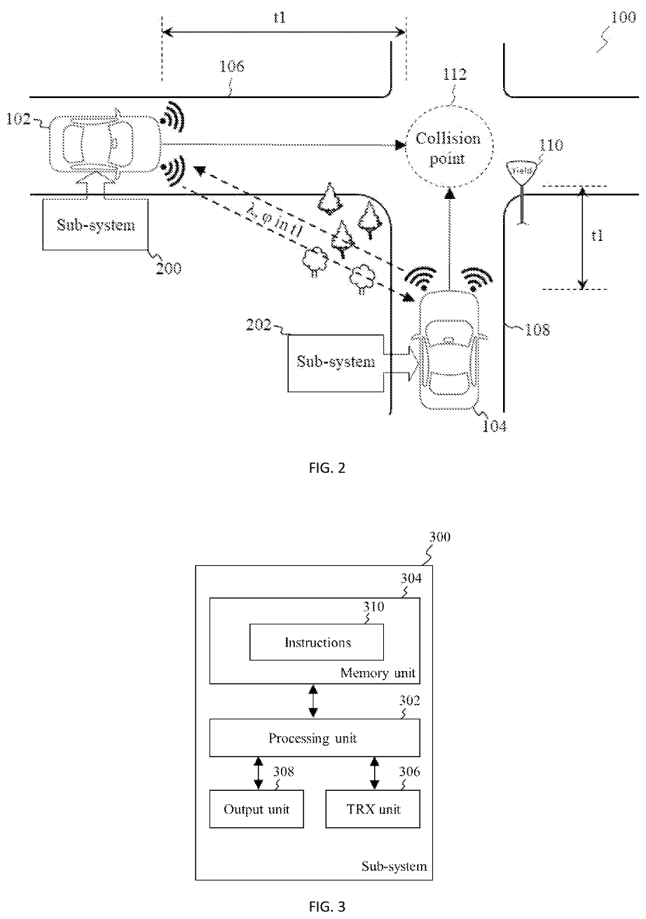

FIG. 2 schematically explains how the inter-vehicle collision described above can be prevented by using a system according to one exemplary embodiment. In this case, the system is assumed to comprise a sub-system 200 mounted in the vehicle 102 and a sub-system 202 mounted in the vehicle 104. Each of the sub-system 200 and 202 may be implemented as a set of units or means each configured to perform one of the functions described below.

The sub-system 200 is configured to continuously receive navigation data comprising geographical coordinates at which the vehicle 102 will be located upon expiry of a threshold time period t1. The geographical coordinates may include, but not limited to, latitude and longitude coordinates, which are schematically shown in FIG. 2 as “A” and “p”, respectively. The sub-system 200 may receive the navigation data from a built-in navigation system (e.g., GPS sensor) of the vehicle 102; correspondingly, the built-in navigation system of the vehicle 102 may set the route for the vehicle 102 along the road 106. It should be known to those skilled in the art that the existing navigation systems installed on vehicles may calculate the coordinates of geographical points in which the vehicle will be in 1, 2 and 3 seconds (or at any other user-defined time intervals) based on the vehicle speed obtained by a corresponding vehicular component (e.g., speed recorder) and/or from the navigation system itself. Additionally or alternatively, the navigation data may be provided to the sub-system 200 from a navigation program installed on a mobile user device, in which the route for the vehicle 102 may be also laid out and on the basis of the route and other data (e.g., from a built-in accelerometer of the mobile user device) the navigation program is able to calculate the geographical coordinates where the vehicle 102 will be in a certain period of time. Some examples of the mobile user device may include, but not limited to, a mobile phone, a cellular phone, a smart phone, a cordless phone, a personal digital assistant (PDA), a wireless communication device, a laptop computer, etc.

By using the navigation data, the sub-system 200 is further configured to determine that the vehicle 102 is approaching the intersection along the road 106. After said determination, the sub-system 200 is further configured to continuously broadcast the navigation data indicating the geographical coordinates of the vehicle 102 at the end of t1. Said broadcasting is schematically shown as wireless communication symbols in FIG. 2 and may involve performing a continuous radio transmission to nearby vehicles (like the vehicle 104) by using a suitable radio transmitter, for example.

The sub-system 202 is configured to continuously receive navigation data comprising geographical coordinates at which the vehicle 104 will be located after t1. Similarly, the navigation data may be provided to the sub-system 202 by a built-in navigation system of the vehicle 104 and/or a navigation program installed on a mobile user device. The sub-system 202 is further configured to use the navigation data to determine the proximity of the vehicle 104 to the intersection. In response to said determination, the sub-system 202 is further configured to monitor the presence of the navigation data broadcast by the sub-system 200 and, if they are present, continuously receive them and compare the geographical coordinates of the vehicle 102 at the end of t1 with the geographical coordinates of the vehicle 104 at the end of t1.

In case of coincidence of the geographical coordinates of the vehicles 102 and 104 at the end of t1 (i.e., when the geographical coordinates of the vehicle 102 at a certain point in time coincide with the geographical coordinates of the vehicle 104 at the same point in time), the sub-system 202 is further configured to determine whether the vehicle 104 must give way to the vehicle 102 at the intersection based on traffic rules. The traffic rules may be based on roadway signs and/or traffic light signals. For example, the sub-system 202 may store a database of all roadway signs within a geographical area of interest that also covers the roads 106 and 108. Alternatively, the roadway sign-related information may be provided to the sub-system 202 by the navigation system of the vehicle 104 and/or the navigation program installed on the mobile user device. In one other embodiment, if the vehicle 104 has a forward-facing camera or a drive recorder, the sub-system 202 may be configured to continuously receive a video image from the forward-facing camera or the drive recorder and determine whether the vehicle 104 must give way to the vehicle 102 at the intersection based on a current signal of a traffic light and/or based on a roadway sign shown in the video image.

Furthermore, if a traffic light is installed at the intersection (say, instead of the “Yield” sign 110), the sub-system 202 may be further configured to receive information about time periods of red and green signals of the traffic light. In this embodiment, the sub-system 202 may determine whether the vehicle 104 must give way to the vehicle 102 at the intersection based on the received information about the time periods of the red and green signals of the traffic light. The information itself may be broadcast by the traffic light, i.e., the traffic light may be equipped with a specially designed unit for performing continuous transmission of said information, e.g., by means of radio or other wireless signals. Alternatively, the sub-system 202 may be further configured to communicate with a remote server or centralized road safety system and download said information therefrom. The information on the time periods of traffic lights operation may allow the sub-system 202 to determine more correctly the order of passing the intersection and to make a decision on the time interval of passing the intersection.

If the sub-system 202 determines that the vehicle 104 must give way to the vehicle 102 at the intersection (i.e., the vehicle 102 has the right of way in this case, which is also supported by the “Yield” sign 110), the sub-system 202 is further configured to notify the sub-system 200 that it (i.e., the sub-system 202) will be responsible for taking a collision avoidance action. After that, if the remaining time until the coincidence of the geographical coordinates of the vehicles 102 and 104 at the end of t1 is less than a first threshold value (i.e., less than 5 seconds), the sub-system 202 is further configured to perform the collision avoidance action by forcibly activating the brakes of the vehicle 104.

It should be noted that said forced activation of the brakes is a last resort measure taken by the sub-system 202 to avoid the inter-vehicle collision in the collision point 112. If there is a sufficient time until the coincidence of the geographical coordinates of the vehicles 102 and 104 at the end of t1, the sub-system 202 may be configured to output a warning signal (e.g., visual and/or audible) to a driver of the second vehicle. The warning signal indicates that the driver needs either to slow down the second vehicle or to fully stop the second vehicle. For example, such a sufficient time may be a time that exceeds the first threshold value by a second threshold value. Numerically, each of the first and second threshold values may be equal to 5 seconds, so that if there are more than 10 seconds until the coincidence of the geographical coordinates of the vehicles 102 and 104 at the end of t1, the sub-system 202 may generate and output the warning signal to the driver; if there is no reaction from the driver, i.e., the vehicle 104 continues to move at the same speed, the sub-system 202 must proceed to the forced braking of the vehicle 104, as discussed above. In general, the threshold values may be selected by the sub-system 202 based on the time required to stop the vehicle 104, i.e., depend on the specific speed at which the vehicle 104 is approaching the intersection.

In one exemplary embodiment, if the sub-system 202 determines that the vehicle 102 must give way to the vehicle 104 at the intersection, it may transmit another notification to the sub-system 200. More specifically, said another notification may indicate that the collision between the vehicles 102 and 104 is possible and that the sub-system 202 will not take the collision avoidance action. In this embodiment, the first sub-system is assumed to be configured to perform the collision avoidance action if the time until the (partial) coincidence of the geographical coordinates of the vehicles 102 and 104 at the end of t1 is less than the first threshold value.

It should be noted that, in general, each of the sub-systems 200 and 202 may be configured in the same or similar manner, so that the sub-systems 200 and 202 may be interchanged in the above-described collision avoidance procedure.

Furthermore, the present disclosure is not limited to the shown number of the vehicles which can be properly managed by the system. In some other embodiments, the collision avoidance procedure described above may be equally used in respect of more than two vehicles approaching the same intersection.

FIG. 3 shows a schematic block diagram of a sub-system 300 according to one exemplary embodiment. More specifically, the sub-system 300 may be used as any of the sub-systems 200 and 202 in the above-described situation 100. In other words, the sub-system 300 may be mounted in each of the vehicles 102 and 104.

As shown in FIG. 3, the sub-system 300 comprises a processing unit 302, a memory unit 304, a transceiving (TRX) unit 306, and an output unit 308. The units 302-308 may be implemented as a single unit mounted in the vehicle 102/104 (e.g., as part of an on-board computer) or distributed somehow in the vehicle 102/104. The memory unit 304 stores processor-executable instructions 310 which, when executed by the control unit 302, cause the control unit 302 to perform those steps of the above-described collision avoidance procedure by using the TRX unit 306 and the output unit 308. It should be noted that the number, arrangement, and interconnection of the units constituting the sub-system 300, which are shown in FIG. 3, are not intended to be any limitation of the present disclosure, but merely used to provide a general idea of how the units may be implemented within the sub-system 300. For example, the processing unit 302 may be replaced with several processing units (each performing a certain function), as well as the memory unit 304 may be replaced with several removable and/or fixed storage devices, depending on particular applications. The TRX unit 306 is configured to perform different operations required for data reception and transmission, such, for example, as signal modulation/demodulation, encoding/decoding, etc. The output unit 308 is configured to output different visual and/or audible information (e.g., it may be implemented as a display, speakers, or their combination). In general, each of the units of the sub-system 300 may be implemented as a hardware component, a software component, or their combination.

Being a hardware component, the processing unit 302 may be implemented as a CPU, general-purpose processor, single-purpose processor, microcontroller, microprocessor, application specific integrated circuit (ASIC), field programmable gate array (FPGA), digital signal processor (DSP), complex programmable logic device, etc. It should be also noted that the processing unit 302 may be implemented as any combination of one or more of the aforesaid. As an example, the processing unit 302 may be a combination of two or more microprocessors.

Being a hardware component, the memory unit 304 may be implemented as a classical nonvolatile or volatile memory used in the modern electronic computing machines. As an example, the nonvolatile memory may include Read-Only Memory (ROM), ferroelectric Random-Access Memory (RAM), Programmable ROM (PROM), Electrically Erasable PROM (EEPROM), solid state drive (SSD), flash memory, magnetic disk storage (such as hard drives and magnetic tapes), optical disc storage (such as CD, DVD and Blu-ray discs), etc. As for the volatile memory, examples thereof include Dynamic RAM, Synchronous DRAM (SDRAM), Double Data Rate SDRAM (DDR SDRAM), Static RAM, etc.

It should be noted that each step or operation of the above-described collision avoidance procedure, or any combinations of the steps or operations, can be implemented by various means, such as hardware, firmware, and/or software. As an example, one or more of the steps or operations described above can be embodied by processor executable instructions, data structures, program modules, and other suitable data representations. Furthermore, the processor-executable instructions which embody the steps or operations described above can be stored on a corresponding data carrier and executed by the processing unit 302. This data carrier can be implemented as any computer-readable storage medium configured to be readable by said at least one processor to execute the processor executable instructions. Such computer-readable storage media can include both volatile and nonvolatile media, removable and non-removable media. By way of example, and not limitation, the computer-readable media comprise media implemented in any method or technology suitable for storing information. In more detail, the practical examples of the computer-readable media include, but are not limited to information-delivery media, RAM, ROM, EEPROM, flash memory or other memory technology, CD-ROM, digital versatile discs (DVD), holographic media or other optical disc storage, magnetic tape, magnetic cassettes, magnetic disk storage, and other magnetic storage devices.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A system for preventing inter-vehicle collisions at an intersection, comprising:
a first sub-system mounted in a first vehicle comprising brakes, the first sub-system being configured to:
continuously receive first navigation data comprising geographical coordinates at which the first vehicle will be located upon expiry of a threshold time period;
based on the first navigation data, determine that the first vehicle is approaching the intersection along a first road; and
continuously broadcast the first navigation data; and
a second sub-system mounted in a second vehicle comprising brakes, the second sub-system being configured to:
continuously receive second navigation data comprising geographical coordinates at which the second vehicle will be located upon expiry of the threshold time period;
based on the second navigation data, determine that the second vehicle is approaching the intersection along a second road different from the first road;
continuously receive the first navigation data broadcast by the first sub-system;
continuously compare the geographical coordinates comprised in the first navigation data with the geographical coordinates comprised in the second navigation data;
if the geographical coordinates comprised in the first navigation data coincide with the geographical coordinates comprised in the second navigation data, determine whether the second vehicle must give way to the first vehicle at the intersection based on traffic rules;
if it is determined that the second vehicle must give way to the first vehicle at the intersection, transmit a notification to the first sub-system, the notification indicating that the second sub-system will perform a collision avoidance action; and
if a time until the geographical coordinates comprised in the first navigation data coincide with the geographical coordinates comprised in the second navigation data is less than a first threshold value, perform the collision avoidance action by forcibly activating the brakes of the second vehicle.

2. The system of claim 1, wherein the second sub-system is further configured to:
if the time until the geographical coordinates comprised in the first navigation data coincide with the geographical coordinates comprised in the second navigation data exceeds the first threshold value by a second threshold value, output a warning signal to a driver of the second vehicle, the warning signal indicating that the driver needs either to slow down or stop the second vehicle.

3. The system of claim 2, wherein the warning signal is at least one of a visual signal and an audible signal.

4. The system of claim 1, wherein the second sub-system is further configured to:
if it is determined that the first vehicle must give way to the second vehicle at the intersection, transmit another notification to the first sub-system, said another notification indicating that: (i) a collision between the first vehicle and the second vehicle is possible, and (ii) the second sub-system will not perform the collision avoidance action.

5. The system of claim 1, wherein the second sub-system is further configured to:
receive information about time periods of green and red signals of a traffic light installed at the intersection; and
determine whether the second vehicle must give way to the first vehicle at the intersection based on the received information.

6. The system of claim 1, wherein the second sub-system is further configured to:
store a database of roadway signs within a geographical area covering the first road and the second road, the roadway signs being part of the traffic rules; and
determine whether the second vehicle must give way to the first vehicle at the intersection based on the roadway signs.

7. The system of claim 1, wherein, if the second vehicle comprises a forward-facing camera or a drive recorder, the second sub-system is further configured to:
continuously receive a video image from the forward-facing camera or the drive recorder;
determine whether a traffic light and/or roadway signs are present in the video image;
if the traffic light and/or the roadway signs are present in the video image, determine whether the second vehicle must give way to the first vehicle at the intersection based on a current signal of the traffic light and/or the roadway signs.

8. A method for preventing inter-vehicle collisions at an intersection, comprising:
by using a first sub-system mounted in a first vehicle comprising brakes:
continuously receiving first navigation data comprising geographical coordinates at which the first vehicle will be located upon expiry of a threshold time period;
based on the first navigation data, determining that the first vehicle is approaching the intersection along a first road; and
continuously broadcasting the first navigation data;
by using a second sub-system mounted in a second vehicle comprising brakes:
continuously receiving second navigation data comprising geographical coordinates at which the second vehicle will be located upon expiry of the threshold time period;
based on the second navigation data, determining that the second vehicle is approaching the intersection along a second road different from the first road;
continuously receiving the first navigation data broadcast by the first sub-system;
continuously comparing the geographical coordinates comprised in the first navigation data with the geographical coordinates comprised in the second navigation data;
if the geographical coordinates comprised in the first navigation data coincide with the geographical coordinates comprised in the second navigation data, determining whether the second vehicle must give way to the first vehicle at the intersection based on traffic rules;
if it is determined that the second vehicle must give way to the first vehicle at the intersection, transmitting, to the first sub-system, a notification indicating that the second sub-system will perform a collision avoidance action; and
if a time until the geographical coordinates comprised in the first navigation data coincide with the geographical coordinates comprised in the second navigation data is less than a first threshold value, performing the collision avoidance action by forcibly activating the brakes of the second vehicle.

9. The method of claim 8, further comprising, by using the second sub-system:
if the time until the geographical coordinates comprised in the first navigation data coincide with the geographical coordinates comprised in the second navigation data exceeds the first threshold value by a second threshold value, outputting a warning signal to a driver of the second vehicle, the warning signal indicating that the driver needs either to slow down or stop the second vehicle.

10. The method of claim 9, wherein the warning signal is at least one of a visual signal and an audible signal.

11. The method of claim 8, further comprising, by using the second sub-system:
if it is determined that the first vehicle must give way to the second vehicle at the intersection, transmitting another notification to the first sub-system, said another notification indicating that: (i) a collision between the first vehicle and the second vehicle is possible, and (ii) the second sub-system will not perform the collision avoidance action.

12. The method of claim 8, further comprising:
receiving, by the second sub-system, information about time periods of green and red signals of a traffic light installed at the intersection; and
determine, by the second sub-system, whether the second vehicle must give way to the first vehicle at the intersection based on the received information.

13. The method of claim 8, further comprising:
pre-storing, in the second sub-system, a database of roadway signs within a geographical area covering the first road and the second road, the roadway signs being part of the traffic rules; and
determining, by using the second sub-system, whether the second vehicle must give way to the first vehicle at the intersection based on the roadway signs.

14. The method of claim 8, wherein, if the second vehicle comprises a forward-facing camera or a drive recorder, the method further comprises, by using the second sub-system:
continuously receiving a video image from the forward-facing camera or the drive recorder;
determining whether a traffic light and/or roadway signs are present in the video image;
if the traffic light and/or the roadway signs are present in the video image, determining whether the second vehicle must give way to the first vehicle at the intersection based on a current signal of the traffic light and/or the roadway signs.
